(19) United States
(12) Patent Application Publication
(10) Pub. No.: US 2011/0047173 A1
(43) Pub. Date: Feb. 24, 2011

(54) METHOD AND SYSTEM FOR FILTERING MATCHING CONTENT

(76) Inventors: James R. Malnati, Stillwater, MN (US); Donald J. Ethen, Brighton, MN (US)

Correspondence Address: UNISYS CORPORATION;Office of the General Counsel, 801 Lakeview Drive, Suite 100, MailStop: 2NW, BLUE BELL, PA, 19422, US

(21) Appl. No.: 12/543,107

(22) Filed: Aug. 18, 2009

(51) Int. Cl. G06F 17/30; G06F 15/16

(52) U.S. Cl. 707/769; 709/206; 707/E17.01; 707/E17.014

(57) ABSTRACT

A computer-implemented method for managing data in a system for automating responses to system messages is disclosed. The method compiles one or more source files into a database, which includes one or more pattern definitions. Matches and non-matches between one or more pattern definitions and one or more system messages are identified and reported in an output file. The method retrieves only the matches from the output file based on one or more predetermined criteria and generates a printed list of the retrieved matches.

### TECHNICAL FIELD

The present disclosure relates generally to management of large volumes of data in a system for automating system, and more particularly to automated identification of patterns in a Console Message Automation environment.

### BACKGROUND OF THE INVENTION

Large-scale computer systems typically incorporate numerous components supplied by disparate manufacturers. Operators at central points in the systems exercise control, generally by receiving system messages and entering system commands. Because the operator often works though a system console, the system messages are referred to as “console messages.” These components usually require unique, often cryptic, commands, and an operator faces considerable difficulty in dealing with the entirety of commands required to control a complex system.

Console Message Automation systems, such as Autoaction Message System (AMS), a product by Unisys, automate complex system operations by embedding required commands in callable pattern files. Single Point AMS and CLEARPATH AMS are two examples of AMS. Each pattern file, stored in an autoaction database, includes message-matching criteria, coupled with and actions to be automatically executed upon matching a system message. Message-matching criteria identify the important parts of a message as well as constraints, such as message length, that must be satisfied for a pattern match. AMS recognizes a system message by comparing it to the pattern definitions in the active autoaction database, and upon determining a match, automatically executes actions defined in the matched pattern.

Pattern files include pattern definitions that characterize the content and context of console messages (the configuration part), and specify the actions to be performed in the event of message match (the action part). AMS uses delimiters (default or user-specified) to separate a message into portions called tokens and to compare the message tokens with the pattern tokens defined in the autoaction database. The “configuration” part provides a pattern identity in a specific “message group” and “message number”, specifies a target message, and identifies which of the message tokens must be identical to produce a match. Other portions of the configuration part may specify a time of day requirement, a variable value required, or other specifications using a CONSTRAINT command. A “match” occurs when the configuration part conditions are met, including the portions of the message defined in a TOKEN command, the number of tokens, the specifications of the CONSTRAINT command, and any other conditions. The pattern definitions can include several other commands such as PRIORITY, TYPE, DELIMITERS, and so on, which are commonly known in relation to AMS systems.

Further, AMS employs a utility, known as Verify Autoaction Database (VADB), to verify the pattern matching and action generation capabilities of the autoaction database. The VADB utility is used to report runtime behavior given an input file of console messages and the autoaction database. Information included in the message input files contributes to creation of the system messages and message characteristics. These messages are then matched against the pattern definitions in the autoaction database. For each additional pattern definition that matches a system message, the associated actions are displayed but are not executed.

VADB accepts log files and console messages as input. Each line in the log file is treated as a message. Because log files are very large, VADB generates a large volume of output. Typically, an AMS auditor puts together a matching collection of output messages (or messages that match a pattern definition in the database) after hours of manual inspection with a highlight marker.

It would be highly desirable to have an automated way of providing a concise, error resistant, and organized report of the matching output. Such a solution would allow auditors to skip the manual inspection step, ensuring maximum productivity.

### SUMMARY OF THE INVENTION

According to aspects illustrated herein, there is provided a computer-implemented method for managing data in a system for automating responses to system messages. The method compiles one or more source files into a database, which includes one or more pattern definitions. Matches and non-matches between one or more pattern definitions and one or more system messages are identified and reported in an output file. The method retrieves only the matches from the output file based on one or more predetermined criteria and generates a printed list of the retrieved matches.

Another embodiment of the present disclosure describes a system for managing data. The system includes a database storing one or more pattern definitions, one or more source files being compiled into the database. The system further includes a data processing system, which is operatively coupled to the database, and includes an identification module, a filter, and a generation module. The identification module identifies matches and non-matches between one or more pattern definitions and one or more system messages. These matches and non-matches are reported in an output file. The system employs the filter for retrieving the matches in the output file based on one or more predetermined criteria. Finally, a printed list of the filtered matches is generated by the generation module.

### BRIEF DESCRIPTION OF THE DRAWINGS

FIG. 1 illustrates an embodiment of a computer-implemented method for managing data in a system for automating responses to system messages.

FIG. 2 is a flowchart of an exemplary embodiment of a computer-implemented method operating in conjunction with an AMS.

FIG. 3 illustrates one embodiment of a system for managing data.

FIG. 4 shows an embodiment of a system for managing data in an AMS environment.

### DETAILED DESCRIPTION OF THE INVENTION

The following detailed description is made with reference to the figures. Preferred embodiments are described to illustrate the claimed invention, not to limit its scope, which is defined by the claims. Those of ordinary skill in the art will recognize a variety of equivalent variations on the description that follows.

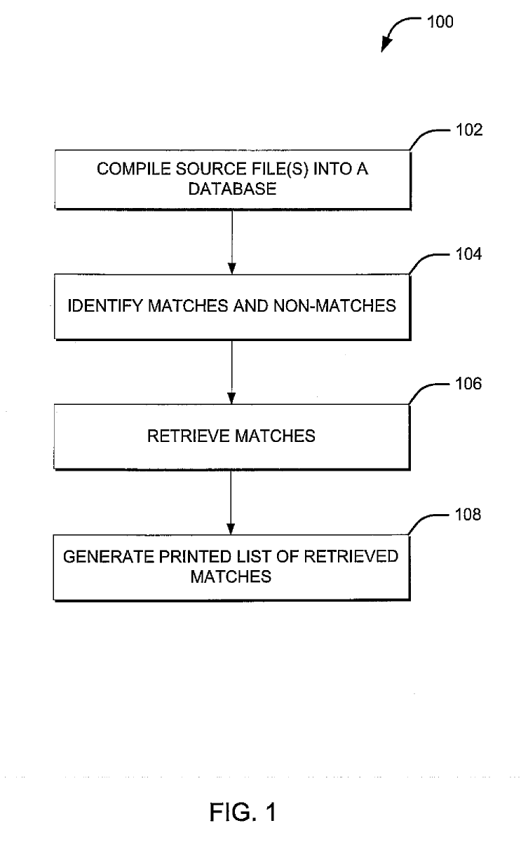

FIG. 1 shows an embodiment of a computer-implemented method 100 for managing data in a system for automating responses to system messages. At step 102, the method 100 compiles one or more source files into a database, which includes several pattern definitions. Matches and non-matches between pattern definitions and system messages are identified at step 104 and reported in an output file. The method 100 then retrieves only the matches from the output file (shown at step 106) based on one or more predetermined criteria. Subsequently, a printed list of the retrieved matches is generated at step 108.

One embodiment of the present disclosure functions in a Console Message Automation environment, such as Autoaction Message System (AMS), a product by Unisys. Here, a Verify AMS Database (VADB) utility performs the identifying step 104.

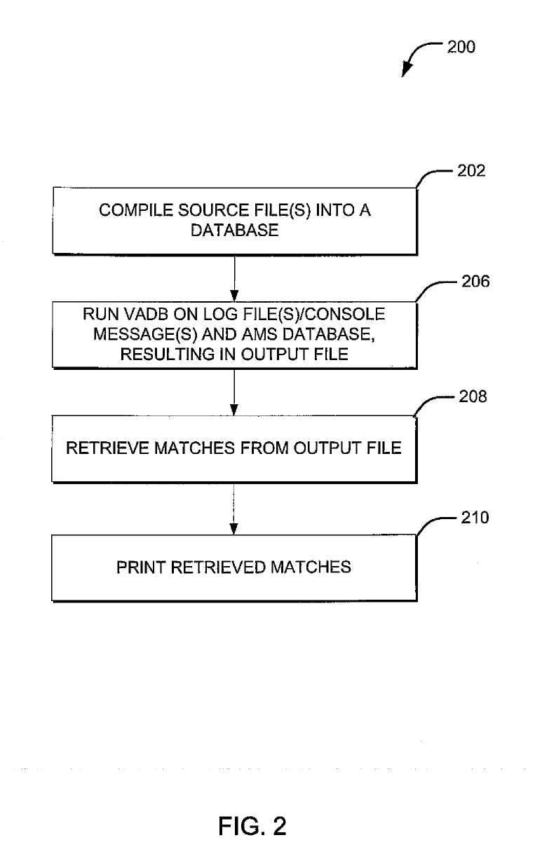

The embodiments discussed in connection with the description of FIG. 2 operate in conjunction with an Autoaction Message System (AMS). Various other embodiments, however, can be anticipated to address many different systems or applications in which a large amount of output needs to be analyzed and arranged in an organized way.

An autoaction database contains a series of pattern definitions. Each pattern definition includes message matching criteria for matching messages from managed systems with actions to be automatically executed when a system message matches a pattern definition. Although a system may possess any number of autoaction databases, only one database at a time can actively match messages for a system.

FIG. 2 is a flowchart of an exemplary embodiment of a computer-implemented method 200 operating in conjunction with AMS. At step 202, the method 200 compiles one or more source files into an AMS database, which includes several pattern definitions.

AMS also employs a Verify Autoaction Database (VADB) utility to verify the pattern matching and action generation capabilities of an autoaction database. For example, VADB can identify conflicting pattern matching rules within a database containing multiple patterns that match a single message.

VADB uses an autoaction database for pattern matching and action generation, the details of which are set out in more detail in the following paragraphs. System log files, which include all console message traffic from a particular time period, serve as input to the VADB utility. The information contained in the message input files is used to create the messages and message characteristics. At runtime, compiled AMS database files (having extensions .ams, .acp or .asp) are provided as input to the VADB utility, along with the log files including console message traffic. The messages are then matched against the pattern definitions in the autoaction database. All pattern matching is performed before any actions are executed, thus circumventing the effect of the actions executed for the first pattern match on the constraints relating to the other patterns for this message.

For each additional pattern that matches a message, the associated actions are displayed but are not executed. The display can take one of two forms, a short report or a long report, each listing matches as well as non-matches. The former provides a quick message match notification, as shown in Table 1. The first two lines in the example display the message accompanied by the word ‘Match’, indicating that this message matches a stored pattern definition. Additionally, the second line in the example presents metadata pertaining to the matching message, such as group name and number. Similarly, the following two lines of output provide information about another message.

TABLE 1
Exemplary VADB output

Message: AMS001: CLEANUP1 ACTIVATED BY AMS UTILITY
Match: group= STARTUP number= 1

| | | |
|---|---|---|
| Message: EXP: 159136 | PRODUC 46R3.05A | T/D 2004-10-05 1620:30 |

Match: group= CHECK-TIME number= 1

The long report format provides considerable information about each message and the pattern definitions it matched, such as the following:

Input message and line number at which the message can be found in the input file

Input message characteristics

Detailed pattern match information

Optional action information

The input message information is followed by the pattern match information. Lines of equal signs separate the processed results of each input message, and a broken line of hyphens indicates the start of the pattern match information, as shown in Table 2. As with the short report, the long report also displays the message. The long report, however, also provides information relating to the message such as input line number, sender and message type, and so on. Following a dashed line, the output specifies whether the message matches any pattern definitions. If a match is found, as is the case for the second message in the present example, in-depth metadata is displayed along with related autoactions.

TABLE 2
Exemplary VADB output

Message: AT 5 L1 FIX(3,352) *EOF* 2334:35
Input line # : 3
Sender type : ANY-SENDER
Message type : OTHER
Instance type: ANY-INSTANCE
No match found:

| | | |
|---|---|---|
| Message: EXP:163236 | PRODUC 46R3.05A | T/D 2004-10-29 0015:27 |

Input line # : 88
Sender type : ANY-SENDER
Message type : OTHER
Instance type: ANY-INSTANCE
Match: group= CHECK-TIME number= 1
DB Text: EXP:exPool PartName ExecLvl T/D CCYY-MM-DD hhmm:ss
Message total token count: 6
Pattern total token count: 6

| | Database | Input |
|---|---|---|
| | Pattern Token | Message Token |
| Token 4: | T/D | T/D |

```
Constraint : (\_TOKEN2\ = “PRODUC” | \_TOKEN2\ = “DEVELO”)
Unattended Mode Actions:
  IF SeqCnt = 0
  ENDIF
```

Thus, running VADB on a given log file or console message and an AMS database results in one or more output files, at step 206. Here, the output files are in the form of the short and long reports. As shown at step 208, the method 200 retrieves the matches from the VADB output file based on some predetermined criteria. Exemplary UNIX shell scripts for retrieving the matches from the VADB output files are illustrated in the following section. Here, the predetermined criterion that the UNIX shell scripts use is the term “Match”, indicating that the message being analyzed matches a pattern definition. These predetermined criteria, however, can be any element identifying the message as a match.

As shown in Table 3, the exemplary UNIX shell script for short report retrieves only the matches from a VADB short report.

TABLE 3
Exemplary Unix shell script for short report

{

| | |
|---|---|
| { if ( $1 ~ “Message:” ) | { mess = substr($0,1,length($0)−1) } } |
| { if ( $1 ~ “Match:” ) | { print mess; print; print “” } } |

}

Table 4 shows how only the matches are retrieved from a VADB long report.

TABLE 4
Exemplary Unix shell script for long report

{

| | |
|---|---|
| { if ( substr($1,1,10) == “==========” ) | # we have the last line in the VADB output |

{ startover=“yes”

| | |
|---|---|
| if ( mtch == “yes” ) | # print the output section to stdout |

| | |
|---|---|
| { print > “tmpfile” | # print the separator line |

close(“tmpfile”)
while (getline < “tmpfile”)

{ print
}
mtch=“no”

}

}

| } | |
|---|---|
| { if ( $1 ~ “Match:” ) | # we have a match in the VADB output |

| # NOTE: “Match” must be a reserved word in awk. | |
|---|---|
| # | If you try to use it as a variable, you get an error. |

| | |
|---|---|
| { mtch=“yes” | # set the match flag |

}

}

# All lines in the file will match this fallthrough section.
# Print conditionally:

| | |
|---|---|
| { if ( startover == “yes” ) | # we hit a separator line |

| | |
|---|---|
| # { print “” > “tmpfile” | # initialize the temporary file |

{ close(“tmpfile”)

| | |
|---|---|
| startover=“no” | # reset the startover flag |

| } | |
|---|---|
| else | # we are within a VADB output section |
| { print > “tmpfile” | # append the line to tmpfile |

}

}

}

Method 200 generates a printed list of the retrieved matches, as shown at step 210. Examples of such lists are shown below, for both, short and long VADB reports in Table 5 and Table 6, respectively. An example of printed list corresponding to short report shows output containing only the matching content from a VADB short report. The layout of the printed list is identical to the layout shown in Table 1, with the exception that only matches are displayed in this printed list.

TABLE 5
Example of printed list corresponding to short report

Message: AMS001: CLEANUP1 ACTIVATED BY AMS UTILITY
Match: group= STARTUP number= 1

| | | |
|---|---|---|
| Message: EXP:159136 | PRODUC 46R3.05A | T/D 2004-10-05 1620:30 |

Match: group=CHECK-TIME number=1

| | | |
|---|---|---|
| Message: EXP:160180 | PRODUC 46R3.05A | T/D 2004-10-05 1625:58 |

Match: group= CHECK-TIME number= 1

Likewise, the layout of an example of printed list corresponding to long report is shown below; and is identical to the layout of shown in Table 2. Again, the only exception here is that only matching content is displayed in the long report.

TABLE 6
Example of printed list corresponding to long report

Message: AMS001: CLEANUP1 ACTIVATED BY AMS UTILITY
Input line # : 7
Sender type : ANY-SENDER
Message type : OTHER
Instance type: ANY-INSTANCE
Match: group= STARTUP number= 1
DB Text: AMS001: db-name ACTIVATED BY source1 source2
Message total token count: 6
Pattern total token count: 6

| | Database | Input |
|---|---|---|
| | Pattern Token | Message Token |
| Token 3: | ACTIVATED | ACTIVATED |
| Token 4: | BY | BY |

```
Unattended Mode Actions:
  IF \_TOKEN5\ = “AMS” & \_TOKEN6\ = “UTILITY”
    RESET CMROpt
    RESET BMISOpt
    RESET AMISOpt
    RESET PSAVE1
    RESET PSAVE2
    RESET BMISSV
    RESET AMISSV
  ENDIF
  IF \_TOKEN2\ = “AMISAPPS”
  ENDIF
```

| | | |
|---|---|---|
| Message: EXP:159136 | PRODUC 46R3.05A | T/D 2004-10-05 1620:30 |

Input line # : 69
Sender type : ANY-SENDER
Message type : OTHER
Instance type: ANY-INSTANCE
Match: group= CHECK-TIME number= 1
DB Text: EXP:exPoo1 PartName ExecLvl T/D CCYY-MM-DD hhmm:ss
Message total token count: 6
Pattern total token count: 6

| | Database | Input |
|---|---|---|
| | Pattern Token | Message Token |
| Token 4: | T/D | T/D |

```
Constraint : (\_TOKEN2\ = “PRODOC” | \_TOKEN2\ = “DEVELO”)
Unattended Mode Actions:
  IF SeqCnt = 0
    SET SeqCnt = 1
    -->1
    IF AMISOpt = “SKIP” | AMISSV = 0
    ELSE
      COMMAND : ST AMSPRO*ECL.AMSDAY, , , 2415DM
    ENDIF
  ENDIF
```

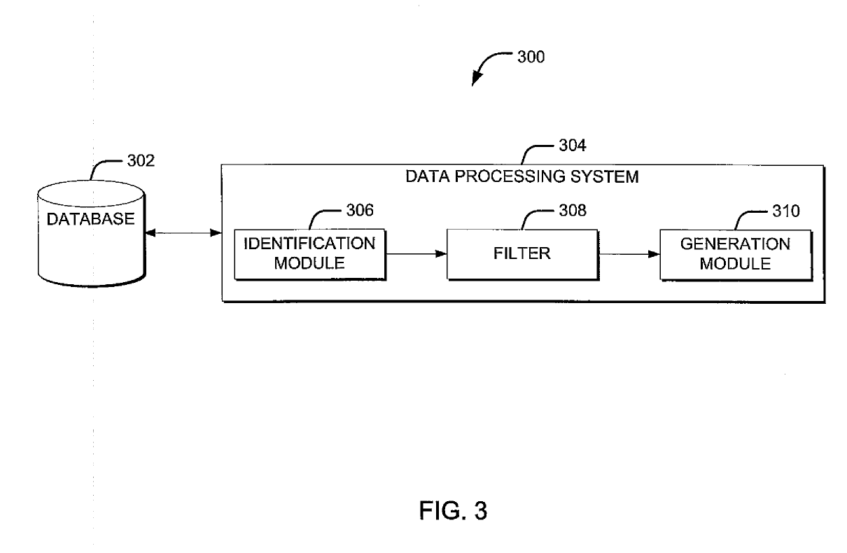

Turning to FIG. 3, one embodiment of a system 300 for managing data is illustrated, based on the present disclosure. Data management systems generate large volumes of output data, making it necessary to identify patterns within the output for executing associated actions. Typically, such a system would require an auditor to assemble a matching collection of output messages (or messages that match a pattern definition in the database) after hours of manual inspection. The present embodiment allows generation of concise and error free reports displaying patterns recognized within the output, and related autoactions.

The system 300 includes a database 302 that includes several pattern definitions, including a number of source files. A data processing system 304, operatively coupled to the database 302, includes an identification module 306, a filter 308, and a generation module 310.

The identification module 306 identifies matches and non-matches between pattern definitions and system messages. An output file reports these matches and non-matches. The filter 308 retrieves only matches from the output file based on one or more predetermined criteria. Subsequently, the generation module 310 generates a printed list of the filtered matches.

In one embodiment of the disclosure, the system 300 operates in a Console Message Automation environment, such as Autoaction Message System (AMS), a product by Unisys. Here, the identification module 306 is the VADB utility, as described above in connection with FIG. 2.

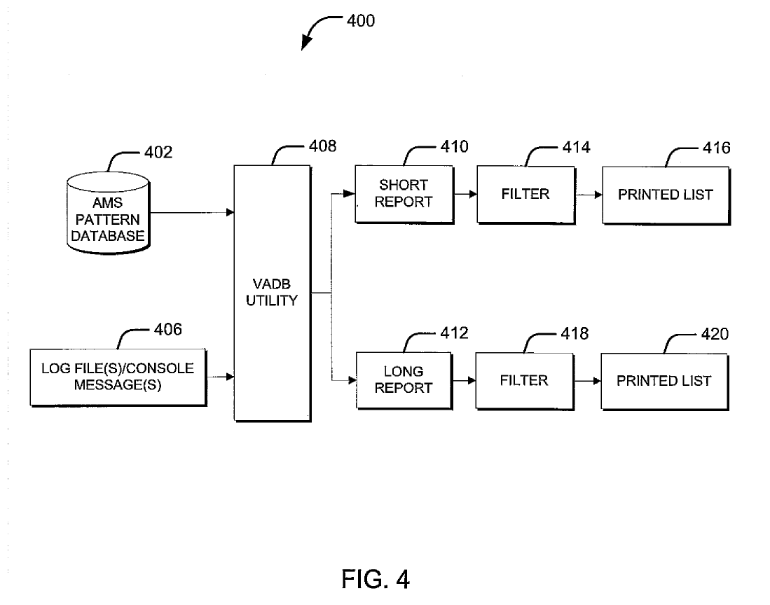

FIG. 4 illustrates an embodiment of a system 400 for managing data in an AMS environment. An AMS pattern database 402 includes several pattern definitions. A log file including console messages 406, along with a runtime, compiled autoaction database, are provided as input to a VADB utility 408. The VADB utility 408 has already been discussed in the description of FIG. 2. For clarity, however, some of the details are briefly described here.

The VADB has two primary output formats—a short report 410 and a long report 412, each listing matches as well as non-matches. The former format provides a quick message match notification, whereas the latter format provides considerable information about each message and the pattern definitions it matched. A filter 414 retrieves the matches from the short report 410 based on some predetermined criteria and creates a printed list 416 of the matches from the short report 410. The matches from the long report 412 are retrieved by another filter 418 based on a predetermined criteria. The system then generates a printed list 420 of the matches retrieved from the long report 412. Here, the predetermined criterion is the word “Match”, which indicates that the message being analyzed matches a pattern definition in the AMS pattern database 402. These predetermined criteria, however, can be any element identifying the message as a match. The result is a concise and organized list of matching content from the VADB output, generated automatically, in a quick and efficient manner.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While this specification contains many specific implementation details of a method and system for managing data in a system for automating responses to system messages, these should not be construed as limitations on the scope of any invention or of what may be claimed, but rather as descriptions of features, that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

We claim:

1) A computer-implemented method for managing data in a system for automating responses to system messages, the method comprising:
compiling one or more source files into a database including one or more pattern definitions;
identifying matches and non-matches between one or more pattern definitions and one or more system messages, wherein the matches and non-matches are reported in an output file;
retrieving the matches based on one or more predetermined criteria; and
generating a printed list of the retrieved matches.

2) The method of claim 1, wherein the database is part of an Autoaction Message System (AMS).

3) The method of claim 1, wherein the identifying step is performed by a Verify AMS Database (VADB) Utility.

4) The method of claim 1, wherein the output file is a short report.

5) The method of claim 1, wherein the output file is a long report.

6) A system for managing data comprising:
a database including one or more pattern definitions, wherein one or more source files are compiled into the database; and
a data processing system operatively coupled to the database, the data processing system including:
an identification module for identifying matches and non-matches between one or more pattern definitions and one or more system messages, wherein the matches and non-matches are reported in an output file;
a filter for retrieving the matches from the output file based on one or more predetermined criteria; and
a generation module for generating a printed list of the filtered matches.

7) The system of claim 6, wherein the identification module includes a Verify AMS Database (VADB) Utility.

8) The system of claim 6, wherein the database is part of an Autoaction Message System (AMS).

9) The system of claim 6, wherein the output file is a short report.

10) The system of claim 6, wherein the output file is a long report.
